(19) United States
(12) Patent Application Publication
(10) Pub. No.: US 2014/0032314 A1
(43) Pub. Date: Jan. 30, 2014

(54) METHOD AND APPARATUS FOR PROVIDING COLLECTION-BASED FEATURE PROGRAMMING

(71) Applicants: Eric James Gieseke, Lincoln, MA (US); Anindita Mahapatra, Methen, MA (US)

(72) Inventors: Eric James Gieseke, Lincoln, MA (US); Anindita Mahapatra, Methen, MA (US)

(73) Assignee: Nokia Corporation, Espoo (FI)

(21) Appl. No.: 13/561,866

(22) Filed: Jul. 30, 2012

(51) Int. Cl. G06Q 30/02

(52) U.S. Cl. 705/14.49

(57) ABSTRACT

An approach for merchandizing online content collections at various layers of a hierarchy is disclosed. A content merchandizing platform determines at least one slot of at least one page associated with one or more content stores, wherein the at least one slot is for presenting one or more content items. The content merchandizing platform also causes, at least in part, an association of at least one collection of the one or more content items with the at least one slot. The content merchandizing platform further causes, at least in part, a selection of at least a portion of the at least one collection to present in the at least one slot.

### BACKGROUND

Network service providers and device manufacturers are continually challenged to deliver value and convenience to consumers by, for example, providing compelling network services. One are of development is providing online services or content (e.g. applications, games, media, etc.) via online stores or repositories. In order to optimize user experience and promote downloads and sales for the online stores, online service providers often feature relevant online services or content items (e.g., top content lists, recommendations, etc.). Generally, such featured services or content items are presented on feature pages (e.g., a home page of an application store) with a number of slots for each featured item. In this scenario, content managers often fill each slot on an item-by-item basis, which can be a potentially significant resource burden particularly when content managers want to update content frequently or feature different products that are suited for local preferences. Accordingly, service providers and device manufacturers face significant technical challenges to enabling content managers (e.g., online store managers) to promote the content items by filling slot-based promotions or feature pages more efficiently.

### Some Example Embodiments

Therefore, there is a need for an approach for providing collection-based feature programming.

According to one embodiment, a method comprises determining at least one slot of at least one page associated with one or more content stores, wherein the at least one slot is for presenting one or more content items. The method also comprises causing, at least in part, an association of at least one collection of the one or more content items with the at least one slot. The method further comprises causing, at least in part, a selection of at least a portion of the at least one collection to present in the at least one slot.

According to another embodiment, an apparatus comprises at least one processor, and at least one memory including computer program code for one or more computer programs, the at least one memory and the computer program code configured to, with the at least one processor, cause, at least in part, the apparatus to determine at least one slot of at least one page associated with one or more content stores, wherein the at least one slot is for presenting one or more content items. The apparatus is also caused to cause, at least in part, an association of at least one collection of the one or more content items with the at least one slot. The apparatus is further caused to cause, at least in part, a selection of at least a portion of the at least one collection to present in the at least one slot.

According to another embodiment, a computer-readable storage medium carries one or more sequences of one or more instructions which, when executed by one or more processors, cause, at least in part, an apparatus to determine at least one slot of at least one page associated with one or more content stores, wherein the at least one slot is for presenting one or more content items. The apparatus is also caused to cause, at least in part, an association of at least one collection of the one or more content items with the at least one slot. The apparatus is further caused to cause, at least in part, a selection of at least a portion of the at least one collection to present in the at least one slot.

According to another embodiment, an apparatus comprises means for determining at least one slot of at least one page associated with one or more content stores, wherein the at least one slot is for presenting one or more content items. The apparatus also comprises means for causing, at least in part, an association of at least one collection of the one or more content items with the at least one slot. The apparatus further comprises means for causing, at least in part, a selection of at least a portion of the at least one collection to present in the at least one slot.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 45-47.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing collection-based feature programming, according to one embodiment;

FIG. 2A is a diagram of the components of a feature programming platform, according to one embodiment;

FIG. 2B is a diagram of a collection object model employed by a content management platform, according to one embodiment;

FIG. 3 is a diagram of an override scenario for at least one slot at one or more hierarchical layers of a content collection, according to one embodiment;

FIGS. 4A-4B are flowcharts of processes for merchandizing online content collections at various layers of a hierarchy, according to various embodiments;

FIG. 5 is a diagram illustrating provisioning and client request sequence for merchandizing online content collections, according to one embodiment.

FIGS. 6A-6D are diagrams of interfaces utilized in the processes of FIGS. 4A-4B, according to various embodiments;

FIG. 7 is a diagram of a client feature promotional page, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for providing collection-based feature programming are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

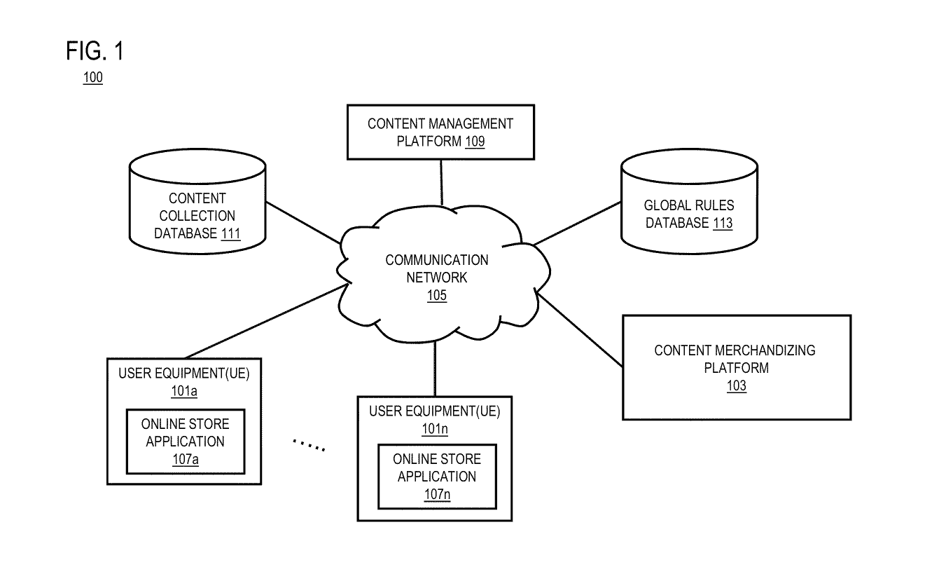

FIG. 1 is a diagram of a system capable of providing collection-based feature programming, according to one embodiment. Featured product promotions can be an important component of merchandising services, products, and other content items. For example, service providers and/or content providers can select a group of items to feature or highlight to users. In some cases, the featured items can be based on recommendation algorithms, promotional considerations, and the like so that special attention can be drawn to those items. In other words, the use of featured product promotions enables store managers to promote items, for instance: (1) to launch a new or updated product; (2) to draw attention to the most popular and/or relevant products; (3) to feature topical and/or regional products.

Typically, online stores feature one or more promotional pages (e.g., a home page of an application store) with limited slots for featuring or promoting content items. The programming or filling of the slots often are specified by various content managers and often at different levels of contextual granularity. For example, given location as one context, content managers may be specified at a global level, a regional level, a country levels, a local level, etc., which each respective manager having authority for their areas of control. Traditionally, content managers have manually programmed which items are to fill which specific slots of the available promotion pages. However, as the number of products and/or content items available in online stores (e.g., an online application or content store) approaches hundreds of thousands (or more) of items, the complexity and burden of such an item-by-item approach to programming the slots can become quite significant. Moreover, other factors such as (1) the number of promoters or managers (e.g., 1 global manager, 7 regional managers, and 50 local managers), (2) the varying of product visibility based on country, device, language, operator, etc., (3) the time-based or time-sensitive nature of some product promotions; and the like can contribute to the overall complexity and burden. In addition, it can be burdensome to specify slots on an item-by-item basis to cover all milieu factors.

To address this problem, a system 100 of FIG. 1 introduces the capability to fill featured slots of a promotion or featured page with a collection of items. In one embodiment, the promotion or featured page may be a web page with one or more slots for presenting promotional information, content items, advertisements, etc. By way of example, each of the slots may display, a content item, a portion of a content collection, or the entirety of the collection. By way of example, generally slots near the top of featured page provides the best content promotion, so in this case the order of the slots can be an important factor in the visibility of the collection or content items in the collection assigned to the slot. In one embodiment, the association of the content collections with the slots may be overridden by content managers at the various hierarchical levels. The overriding pertains to the extent of permission or authorization granted to a content manager at one hierarchical level for affecting the presentation of content collections or items in the slots defined at other levels. This includes, for example, permissions for sorting content, defining slots, eliminating content, adding content, etc.

In one embodiment, the content item or items to present in a slot filled with a content collection may be selected from the content collection based on the user milieu information. The user milieu information may include location information, user information, device information, preference information, buying history and habits information, and/or any other data for characterizing one or more users, devices, or a combination thereof. The top content items matching the user milieu information may be filled in the slot. In one embodiment, the content items in the content collections may also be selected based on a randomization of the content items. In one embodiment, the content items may be selected or sorted dynamically based on the rules. For example, the collection may be defined using a rule for determining the characteristics of the items that are to be included in the content collection. In this way, as new content items matching the rules became available, the system 100 can automatically add the items to the appropriate collection. In yet another embodiment, the collections and content items of the collections may be selected to avoid duplication of content items or collections appearing in the slots of a particular promotion or featured content page. For example, if a certain content item is already filled in one slot, the same content item may be disallowed from filling another slot.

In one embodiment, the association of the content collections with the slots may be determined based on contextual parameters (e.g. day of week, location, activity, language, etc.). The contextual parameters may include temporal parameters such as day of week, seasons, holidays, etc. For example, the content collections for summer season (e.g., contents related to swimming, vacation, travel, ocean or sea, etc.) may be associated with a slot during summer. In one embodiment, the content collections in the slots at certain hierarchical level (e.g., location based hierarchies for different granularities of geographical areas such as global, regional, local, etc.) may be overridden by content managers at lower hierarchical levels. For instance, a content collection of game content items associated to a slot by a global manager may be overridden by a content collection of movies content items by a U.S. regional manager. In one embodiment, if some slots are unfilled by the content collections, backfill rules may be processed to cause filling of the unfilled slots. For example, backfill rules may be any conditions that are associated with the contents to be filled in the slots. The content collections may be backfilled in a slot automatically if the slot is determined as unfilled. In that way, the system 100 avoids potential holes or unfilled slots on the promotion page.

The content collections may include, for example, any grouping of content items. In one embodiment, the content collection may be defined based on whether the items share one or more common attributes. Within the context of an online store, a collection may be defined to support a theme pack, advertising campaigns, home page of one or more companies, a recommendation list, etc. Attributes of a collection may therefore include those reflecting the interests of the users to which the content is directed, such as based on a common geographic location, demographic, or a combination thereof. By way of example, milieu information pertaining to the user, which includes information pertaining to the context of the user or a device of the user, may be matched with a corresponding collection. In one use case under this scenario, a collection of sports related content targeted may include multiple bins such as one bin for patrons living in a particular city that may feature content related to the local football, baseball, soccer and other sports teams of that locale, and another bin of content representing a group of national football, baseball, soccer, etc. teams for users associated with milieu information indicating a national preference.

The content or content item may include, for example, any data capable of being accessed, retrieved, downloaded, or otherwise executed by a calling application such as a web browser, online store application, or the like. By way of example, content may include video data, audio data, image data, internet data, data files, executable object code (e.g., applications or games), web services, contextual and semantic data, textual data and the like. In certain embodiments, the content management platform 109 enables content to be added to one or more collections at various hierarchical or organization layers. Then, the content promotion platform 103 may enable the content collections to be associated with slots of a promotion page. By way of example, the hierarchical or organizational layers may correspond to a management structure of the service provider (online store host), a level of jurisdiction or responsibility of one or more operators of the service provider, a level of granularity of consumer interests, a level of access to the content management platform 109, content promotion platform 103, etc. For the purpose of illustration, the exemplary techniques are described from the perspective of a hierarchy comprising a global, country and regional hierarchical structure.

By way of example, the global layer corresponds to a global layer of online content management as managed by a global content manager; the country layer corresponds to a country level of online content management as managed by a country content manager; and a regional layer corresponds to a regional level of online content management as managed by a regional content manager. The content manager at a respective layer creates, via the content management platform 109, a bin for specifying content to be included at his or her respective level of the content collection based on the corresponding layer. For example, a global bin may specify or contain content corresponding to the global layer, while a regional bin at the regional layer maintains the content that will be presented to users at the regional layer. Each bin contains an ordered list of content comprising at least a portion of the collection. In one embodiment, content from different bins at different hierarchical layers may be combined using, for instance, one or more algorithms to reconcile duplicates, sort orders, etc. across the multiple bins to provide a coherent list to the user. The managers at different hierarchical layer may also associate, via the content promotion platform 103, content collections with the slots based on the manager's level of the hierarchy. The managers at lower hierarchical level may be able to override the content collections associated in the slots by the manager at higher hierarchical level.

In other words, the interaction between the various layers, including their order of priority and specific override privileges, is defined according to one or more rules. Rules are specified or applied at a global level, country or regional (local) level (e.g., affecting filtering of content from the collection based, at least in part, on one or more criteria such as location, operator), or a combination thereof. In addition, the rules specify one or more filters, rules or executions for defining the means of content selection and programming. This capability, for instance, enables the service providers to direct content for specific product promotions (e.g., whitelists) or to prohibit content (e.g., blacklists) in the online store for specific hierarchical levels such as countries, regions, etc. It is noted that any number of hierarchical layers representing, for instance, varying levels of granularity of the hierarchical structure may also be implemented in certain embodiments, e.g., city layer, postal zip code layer, campus layer, community layer, etc.

By way of example, one way of controlling the content items or bins of a content collection presented on a user equipment is via a set of filters that are defined for each of the available slots in the structure of the online store promotion page. These filters control how content is selected to appear on the promotion page based on criteria such as recent activity, price, category, etc. It is noted that content priorities may also differ for different devices, countries, regions, languages, etc. They may also differ according to user's specific needs. Moreover, the rules or filters can be edited periodically based on current promotions, user interest, and other user milieu information.

Rules for defining override capabilities at respective hierarchical layers are also defined. Overrides may include a level of importance or priority of one layer versus another, a degree of content selection and management privileges of one level versus another, or a combination thereof, a level of data overwriting and/or deletion capability at one level versus another, or a combination thereof. By way of example, Table 1 presents the examples of behavior of the online store for supporting selection, presentation, or modification of collections at various hierarchical layers.

TABLE 1
BIN ALLOCATION/MANAGEMENT
At least one bin must be defined, but others are optional.
One global bin, but multiple regional and country level bins may exist
per collection_{—}
CONTENT SELECTION
Content selection starts with country bin, then regional bin and finally
global bin.
Duplicate content is filtered from a resulting bin
Sort order or content selections are preserved
OVERRIDES
Content selection starts with country bin, then regional bin and finally
global bin
Changes to the collection at the global layer (global bin) descended and
are visible to the regional and country bin
Changes at the regional layer (regional bin) are visible to the country level
(country bin)
Country level changes do not affect the parent region (e.g., a Pacific
Region may include multiple countries)
Regional level changes do not affect global bin configuration
Country has precedence over region, region has precedence over global

As shown in FIG. 1, the system 100 comprises a user equipment (UE) 101 having connectivity to the content promotion platform 103, and the content management platform 109 via a communication network 105. By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

In one embodiment, the content promotion platform 103 enables managers to configure the arrangement and presentment of content collections in the slots of the promotion page for the UEs 101. For example, the content promotion platform 103 may associate content collections with the slots so that the content collections are presented on the promotion page and displayed on the UE 101. The content collection may be selected to be included in the slot a portion of the content collection or entirety of the collection. Further, the content promotion platform 103 may also enable the content managers at various hierarchical level to override the content collections associated the slots. In that way, the global content collections may be tailored to specific needs of each hierarchical level. For example, the content collections associated to the slots by a global manager may be overridden or modified by a regional manager at regional level, and those collections modified by the regional manager may be modified by a country manager and so on. The modification may include adding, removing, replacing, or overriding the content collections associated with the slots. The content promotion platform 103 may include a manager interface that enables the content managers to modify the content collections in the slots of the promotion pages at appropriate level of the hierarchy.

In one embodiment, the content management platform 109 enables managers to configure, based on the rules, the arrangement of contents or content collections in one or more bins for the slots of the promotion page. For example, when a bin modified by a content manager at a global level is caused to include a new selection, the promotion page at the regional and country layer is adapted to present this content as well. The content management platform 109 fetches from global rules database 113 the global rules, which indicate that changes to the content collections at the global layer (global bin) descended and are visible to the regional and country bin. The content management platform 109 also enables the content managers to apply the overriding filters (e.g., local rules or filters) on the global rules in order to tailor the global rules to the specific needs of each group of user equipments based on factors such as local restrictions, device configuration, user preferences, etc. The content collections may be maintained in content collection database 111.

In one embodiment, the respective online store application 107 of each UE 101 receives the aggregated set of content collections and displays the content collections on the promotion page on the UE 101 for the user selection. The online store application 107 may also collect data on user behavior regarding the selection of services as well as context information. Collected data (e.g., milieu information) can be transferred to the content management platform 109 and content promotion platform 103 to be used for affecting subsequent presentment of collections associated with one or more bins.

By way of example, the UE 101, the content promotion platform 103, the content management platform 109, the content collection database 111, and the global rules database 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

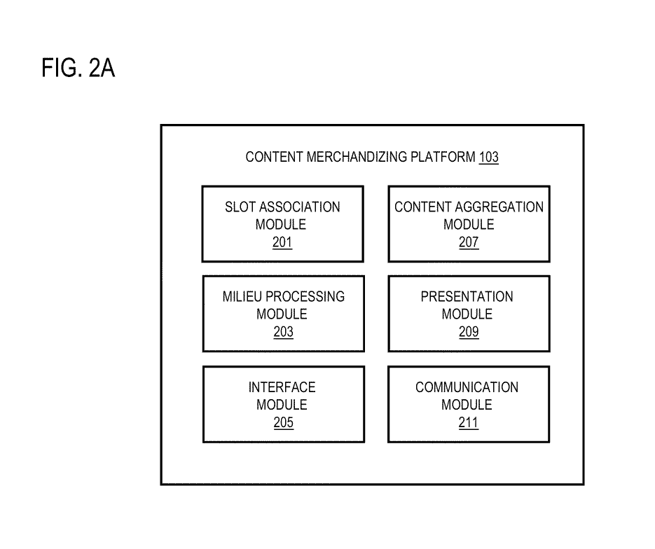

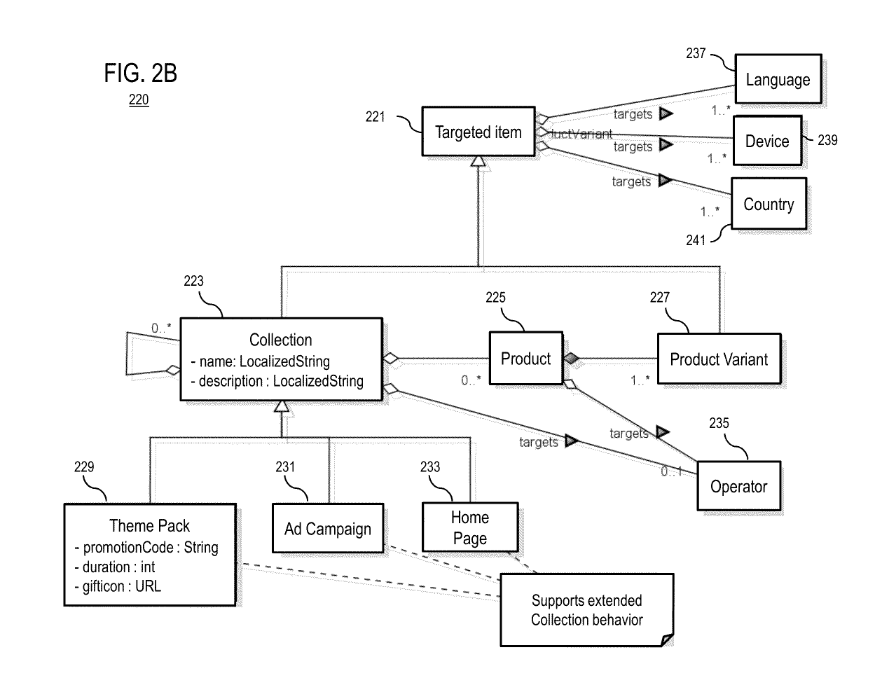

FIG. 2A is a diagram of the components of the content promotion platform 103, according to one embodiment. By way of example, the content promotion platform 103 includes one or more components for providing collection-based feature programming. It is contemplated that the functions of these components may be combined in one or more components or performed by other components of equivalent functionality. In this embodiment, the content promotion platform 103 includes a slot association module 201, a milieu processing module 203, an interface module 205, a content aggregation module 207, a presentation module 209, and a communication module 211.

In one embodiment, the slot association module 201 may associate the content collections with the slots of the promotion page. For example, one or more content items from a content collection may be used to fill a slot to which the content collection is assigned. In one embodiment, the content items of a collection may be ordered with, for instance, the top content item or items matching user milieu information filling the slot. In one embodiment, the content collection may be a static content list or a dynamic content list. A static list, for instance, includes a fixed set of defined content items. On the other hand, a dynamic content list includes rules for defining what items to include in a content item. By way of example, the rules can act as queries for searching for content items based on one or more parameters. Items matching the parameters or criteria are then automatically added to the collection.

In one embodiment, the slots may be optionally filled with the content collections based on user selection and/or manager discretion. The association of the content collections with the slots may be based on one or more contextual parameters (e.g., day of week, locations, activities, etc.). In one embodiment, the contextual parameters may be temporal parameters such as day of week, seasons, holidays, etc. For example, a content manager may specify that a certain slot is to be filled with a first content collection on weekdays and a different content collection on weekends.

In one embodiment, the system 100 may provide for backfilling rules for slots that are not filled by the content collections or for when no content items in the content collections are available to fill an assigned spot. The backfill rule may define when, how, or with what the slots need to be filled. Accordingly, the backfilling rules can be used to ensure that no slot remains unfilled or empty on a page. For example, the backfilling rule may provide for selection from among a default set of content items or from one or more content collections assigned to other slots on the promotion page. In some embodiments, the slots may be re-associated with different content collections due to an overriding by the content managers.

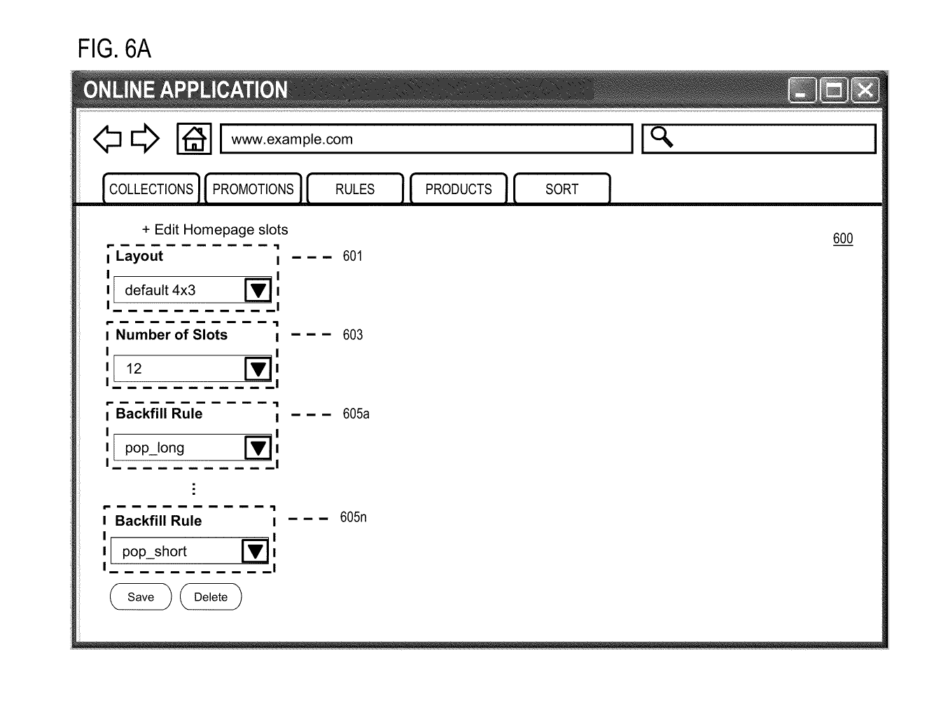

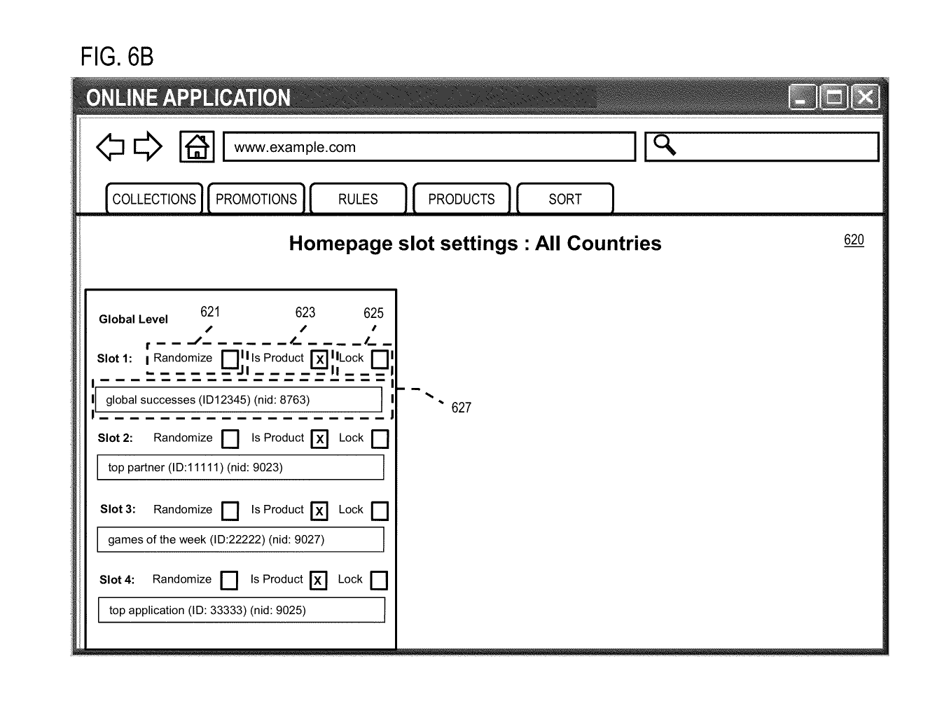

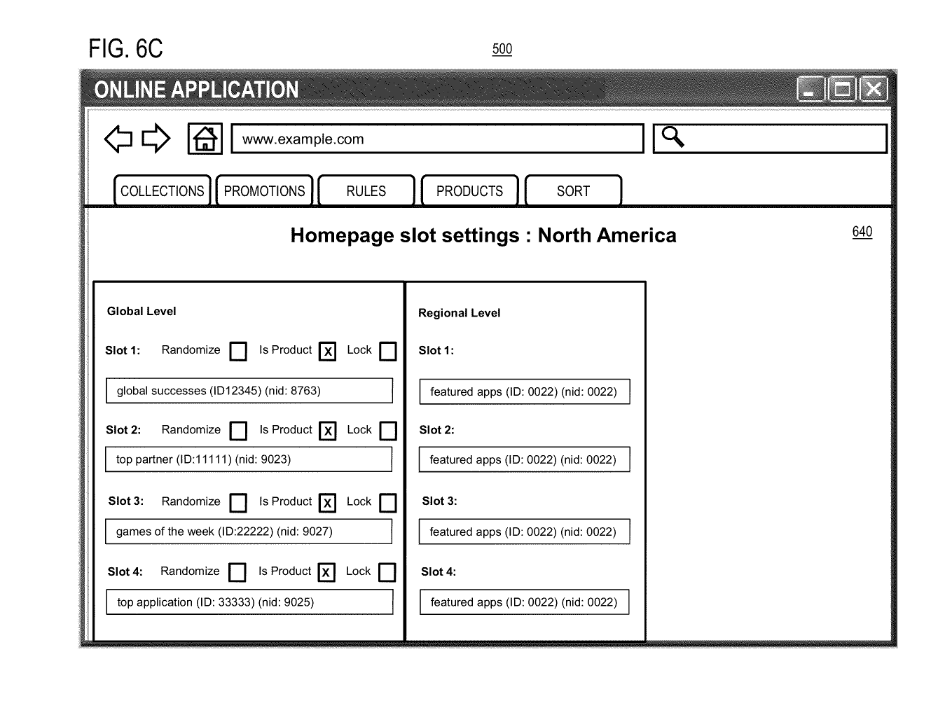

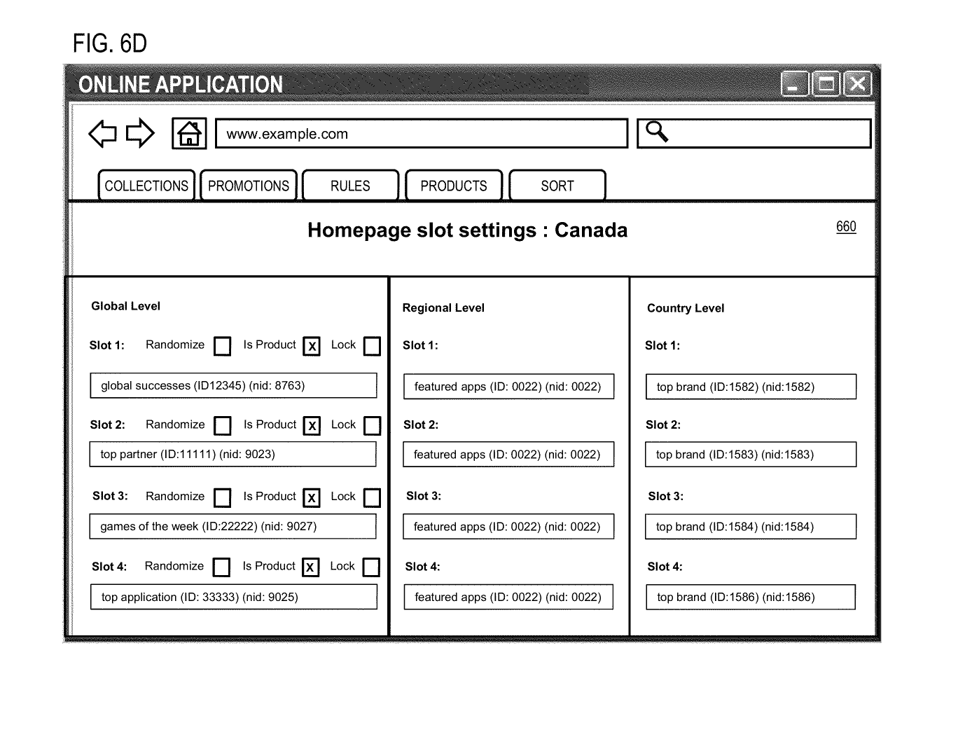

In one embodiment, the interface module 205 may provide a manager interface that enables the content managers to modify the association of content collections with the slots in the promotion page at appropriate level of the hierarchy. For example, the manager interface may enable the manager to configure layouts of the slots for the promotion page (e.g., default 4×3, 5×5, 3×7, etc), a number of the slots, backfilling rules, etc. Further, based on the level of the hierarchy, the manager interface may display setting pages for the appropriate hierarchical levels. The view and selection of the content collections may be limited based on the level of the hierarchy. For example, the global content manager may be able to view the global setting page, and the regional content manager may be able to view the regional setting page. The managers at different hierarchical level may be able to view the setting at different hierarchical level but may not be able to modify the setting (e.g., in case the modifying manager is in a higher hierarchical level). The manager interface is further described below in regard to FIG. 6A-6D.

In one embodiment, the milieu processing module 203 may be configured to process milieu information pertaining to one or more users or devices having access to the online store. Milieu information may include location information, user information, device information, preference information, buying history and habits information, and/or any other data for characterizing one or more users, devices, or a combination thereof. The milieu processing module 203 processes the information to determine one or more bins of a collection that may match a request for access to content by the content promotion platform 103 or the content management platform 109. This ensures selecting content items that match the milieu information when the slot association module 201 associates a content item or content collections to a slot based on the milieu information.

In one embodiment, the content aggregation module 207 may generate content collection structures for content collection database 111. The contents may be grouped or organized based on certain criteria, such as themes, topics, content types, etc. In one embodiment, the presentation module 209 may present content collections in bins associated with the slots in the promotion page. The online store application 107 of the UE 101 may receive the bins associated with the slots, and display the content collections associated with the bins in the promotion page on the UE 101. In one embodiment, the communication module 211 may enable connections and data transmissions between the content promotion platform 103 and the UE 101, the content management platform 109, the content collection database 111, or the global rules database 113 via the communication network 105.

FIG. 2B is a diagram of a collection object model employed by the content management platform 109, according to one embodiment. As shown, the object model 220 includes a collection of objects and/or classes conforming to a specific object oriented programming language (e.g., Java). For example, a collection class 223 may be defined to include attributes ‘name’ and ‘description,’ corresponding to the name and description of an instance of a collection. Associated with the collection class 223, as linked, are product classes 225 and operator 235. These classes 225 and 227 correspond to an instance of a product and operator respectively. By way of example, multiple instances of products and/or operators may be linked to a single collection. In addition, a product variant class 227 may be further linked to the product class object 225 for enabling variations of products (e.g., color variation, feature variation) to be further associated with an instance of a collection.

A top level class 221, classified as targeted item, is linked to the collection class 223 or product variant class 227. By way of example, the targeted item class 221 may correspond to a bin of a collection. The targeted item class 221 is linked to a language class 237, device class 239 and country class 241, which correspond to specific targeted characteristics for defining a bin at a particular hierarchical layer of the collection. For example, the targeted classes 237-241 may include attributes for matching against milieu criteria of a given user and/or device attempting to activate a bin of the collection. Collections and/or bins are therefore targeted by country, device, language, and operator, such as to enable context based product boosting and hierarchical bin specification.

The collection class 223 is also linked to a theme pack class 229, advertisement campaign class 231 and home page class 233. The theme pack class 229 is further defined to include promotionCode, duration and gifticon attributes, corresponding to a specific promotional code value, theme or offer expiration date and icon for representing a specific promotion or theme. The advertisement campaign class 231 and home page class 233 support one or more instances of an advertisement campaign (e.g., marketing message) or website featuring online store content. It is noted that each of these classes 229-233 support extended content collection behavior.

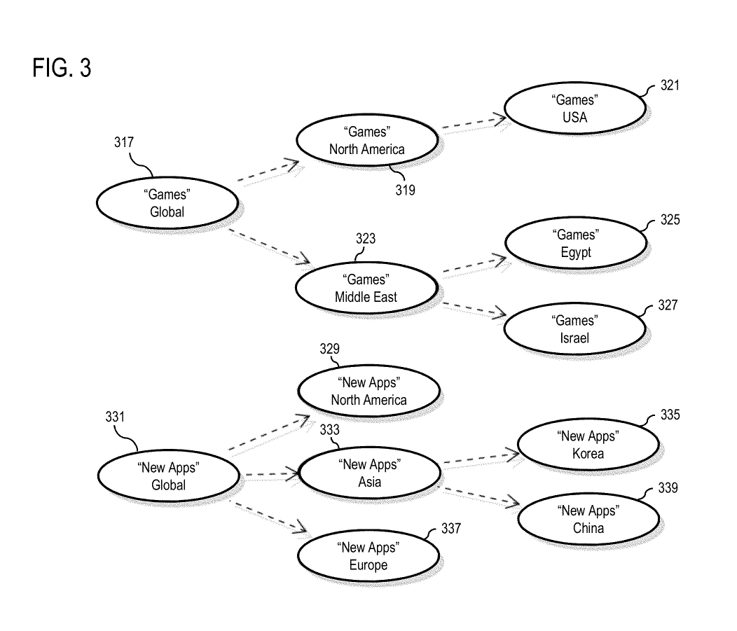

FIG. 3 is a diagram of an override scenario for one or more bins at one or more hierarchical layers of a content collection, according to one embodiment. As noted previously, overriding pertains to the extent of permission or authorization granted to a content manager at one hierarchical level for affecting the presentation of contents in the slots at other levels. This includes, for example, permissions for sorting content, defining slots, eliminating content, adding content, etc. By way of example, the exemplary use case scenario depicts an interaction between content managers operating at different hierarchical levels, including a global store manager, regional store manager and country store manager. Global store managers specify a content or content collection at a global level, regional store managers can modify at a regional level, and the country store manager can modify at the country level, and so on.

Under this scenario, the global store manager specifies content for inclusion in a bin 317 named “Games” at a global layer as part of a games content collection. The regional store manager for the Middle East region augments the content included in the collection 317 to generate a “Games” bin for the Middle East 323. By way of example, the regional store manager adds content popular in the region as well as removes content that may be perceived as offensive to customers in that region (e.g., based on cultural, religious and/or language differences). Another regional store manager for the North American region also generates a “Games” bin 319, augmented to include content of interest to that region.

A country store manager for the country Israel further refines the “Games” bin for Israel 327, while a manager in Egypt refines the preceding “Games” bin 323 to produce a bin 325 suitable for that region. This may include, for example, adding and removing content from the collection as suited for Israel and Egypt. A “Games” bin 321 for the United States of America is also generated as a modification of its regional counterpart 319.

According to the override rules of the various embodiments described herein, the bins at the more specific hierarchical will override the less specific layers above. For example, because bin 319 for North America and bin 323 for the Middle East have been specified, users from those regions will see the more specific content items of bins 319 and 323 rather than the more general bin 317. For user from other regions, they will be presented with the list of game items from the global bin 317, because no more specific bin has been specified for them. As shown, a more specific bin 321 for the USA has been specified from the North American bin 319; and bin 325 for Egypt and bin 327 for Israel has been specified from the Middle Eastern bin 323. Accordingly, users from the USA, Egypt, and Israel will be presented with a more specific list of games from their respective bins.

As another example, a global store manager specifies content for inclusion in a bin 331 named “News Apps” at a global layer as part of a news apps content collection. The regional store managers for North America, Asia and Europe augment the news apps collection to generate respective bins 329, 333, and 337 appropriate for the respective regions they represent. For the Asian bin 333, country managers for Japan and China have also specified, respectively, more specific bins 335, and 339. As described in the process above users whose milieu information matches the location criteria for each bin will be presented with the list of news apps appropriate for their location.

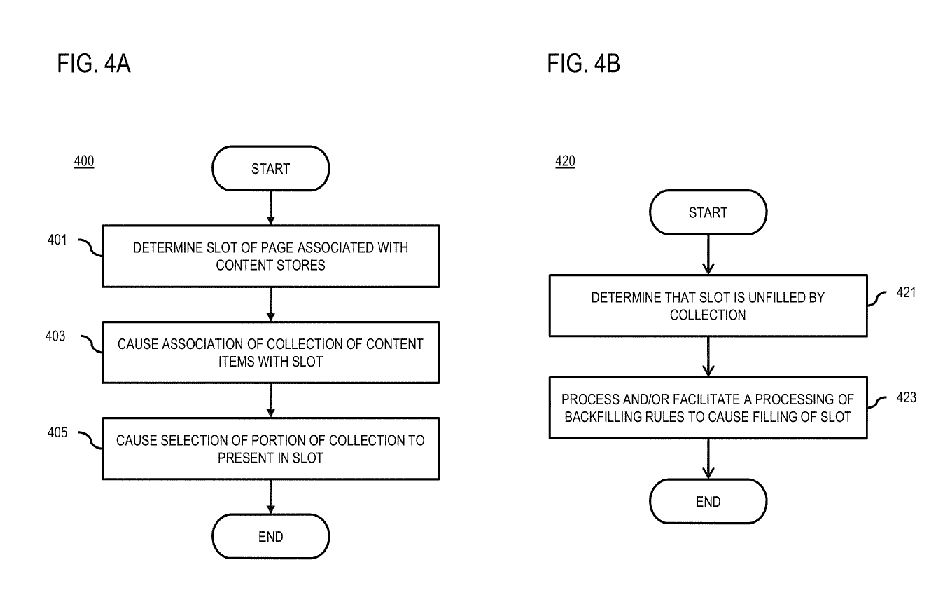

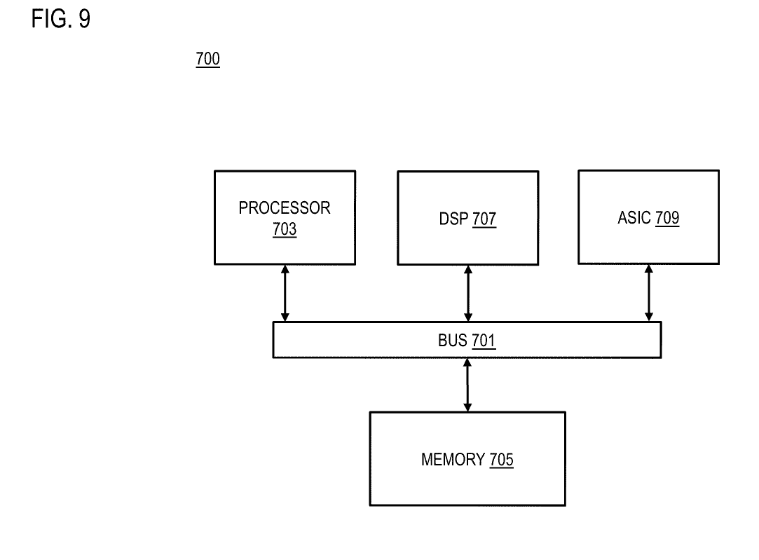

FIGS. 4A-4B are flowcharts of processes for merchandizing online content collections at various layers of a hierarchy, according to various embodiments. In various embodiments, the content promotion platform 103 performs the processes 400 and 420, and are implemented in, for instance, a chip set including a processor and a memory as shown in FIG. 9.

In step 401 of the process 400, the content promotion platform 103 may determine at least one slot of a least one page associated with one or more content stores. The at least one slot is for presenting one or more content items. The at least one slot may be associated with at least one collection of the one or more content items (step 403). At least a portion of the least one collection may be selected to be presented in the at least one slot (step 405). The selection of the at least a portion a portion of the least one collection in step 405 may be determined based on user milieu information. Further, the selection in step 405 may be determined based on a randomization of the one or more content items in the at least one collection. Furthermore, the selection in step 405 may be determined based on an avoidance of a duplication of the one or more items with respect to the at least one slot. In addition, the selection in step 405 may comprise the at least one collection in at least substantially its entirety. In that way, at least one content collection may be presented in the at least one slot of the at least one page. In the meantime, one or more rules for specifying the one or more content items in the at least one collection may be processed.

In one embodiment, the association of the at least one slot with at least one collection of the one or more content items in step 403 may be determined based on one or more contextual parameters. The one or more contextual parameters may include one or more temporal parameters. Further, the association in step 403 may be determined at a first hierarchical level. Then, an input at a second hierarchical level that causes an overriding of the association may be determined. The first hierarchical level and the second hierarchical level may be based on a global level, a regional level, a local level, or a combination thereof.

In step 241 of the process 420, the content promotion platform 103 may determine that the at least one slot is unfilled by the at least one collection. Then, one or more backfilling rules that causes a filling of the at least one slot may be processed (step 423).

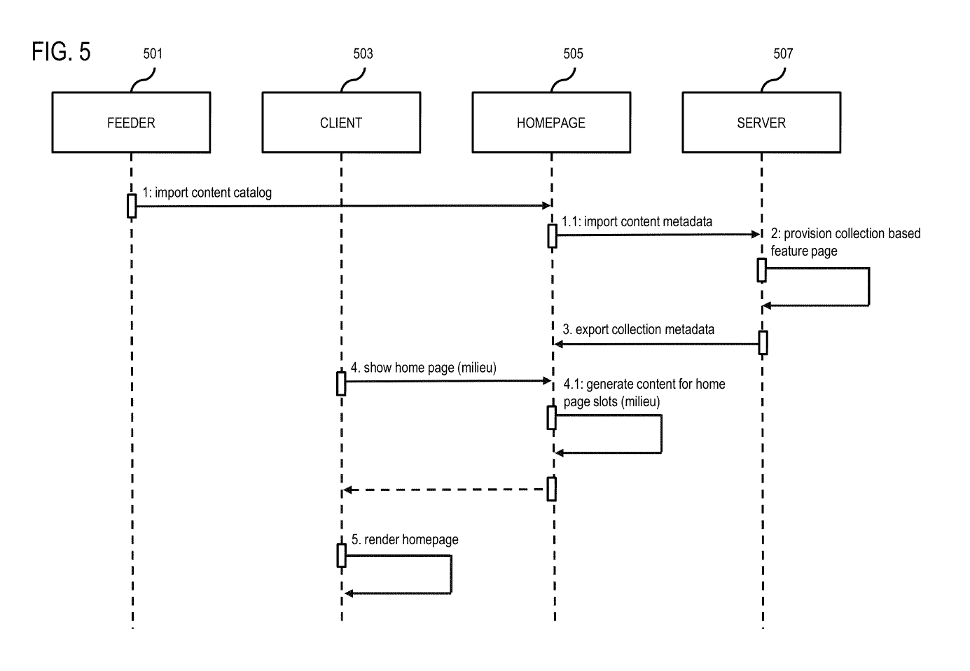

FIG. 5 is a diagram illustrating provisioning and client request sequence for merchandizing online content collections, according to one embodiment. By way of example, a homepage 505 may import a content catalog associated with content collections from feeder 501, which may be associated with content management platform 109. The home page 505 may be a feature page or a promotion page and may be associated with the content promotion platform 103. The server 507 may import content metadata associated with the content catalog from the homepage 505. The server 507 may be associated with the content promotion platform 103. Then, the server 507 may provision a collection based feature page and export collection metadata associated with the feature page to the homepage 505. Meantime, a client 503 may send a request to the homepage 505 along with milieu information associated with the client 503. The client 503 may be associated with the UE 101. Upon receiving the request, the homepage 505 may generate/allocate contents or content collections for homepage slots based on the milieu information. Then, the homepage 505 may send a response back to the client 503 with the homepage information. As a result, the client 503 renders the homepage on a display of the UE 101.

FIGS. 6A-6D are diagrams of interfaces utilized in the processes of FIGS. 4A-4B, according to various embodiments. The interface may be a manager interface that enables the content managers to modify the association of content collections with the slots in the promotion page at appropriate level of the hierarchy. By way of example, as shown in FIG. 6A, a general setting page 600 may enable a configuration of the slots in the promotion page. The general setting page 600 may comprise a layout selection 601, which defines the grid layout for the slots (e.g., default 4×3, 5×5, 3×7, etc.). The general setting page 600 may also comprise a selection for number of slots 603, which defines number of slots to be displayed or filled on the promotion page. The setting page may further comprise one or more backfill rules 605, which define how the slot is filled when there is no content matching the user milieu within the collection associated with the slot.

In FIG. 6B, by way of example, a global setting page 620 for global managers is shown. The global setting page 620 may comprise a randomize option 621, which randomize the content selection from the collection. The global setting page 620 may also comprise an is-product option 623, which, if selected, displays the first sorted item in the collection and if not selected, it displays the collection itself. The global setting page 620 may further comprise a lock option 625, which, if selected, does not allow an overriding by lower hierarchical level managers (e.g., regional or local store managers). In this scenario, a global store manager defines default slot content for all regions and countries. Each of the slots is associated with a collection. In FIGS. 6C and 6D, similar features and attributes in different hierarchical levels are shown. In this scenario, FIG. 6C is a regional setting page 640 to be shown and modified by a regional store manager in North America, and FIG. 6D is a country setting page 660 to be shown and modified by a country store manager in Canada.

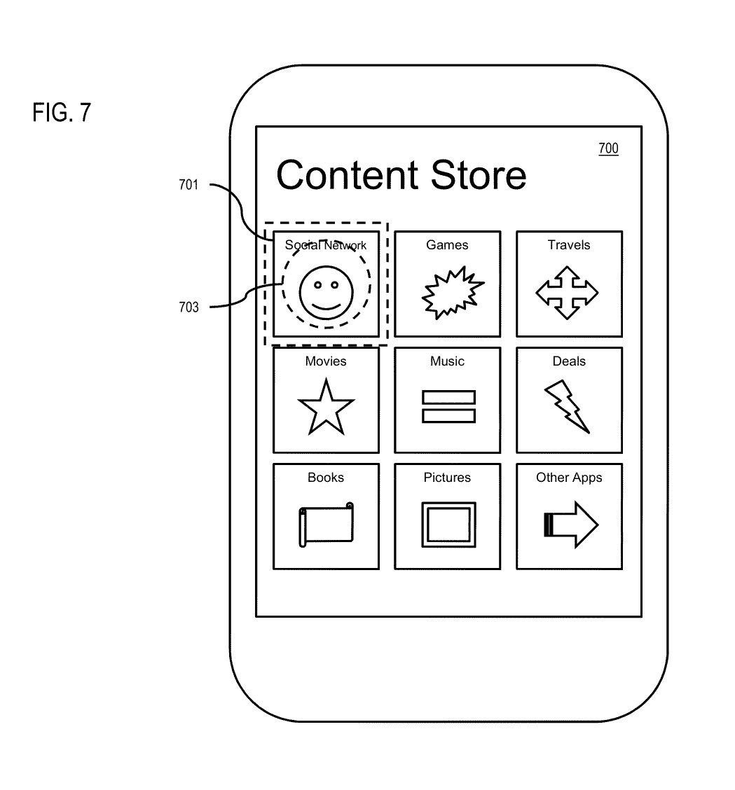

FIG. 7 is a diagram of a client feature promotional page 700, according to one embodiment. By way of example, the client feature promotional page 700 may display contents or content collections 703 according to slot association. If a content or product is displayed in the slot, a user may be able to see the product details by selecting the slot. If a content collection is displayed in the slot, a user may be able to see a list of contents in the content collection by selecting the slot. A slot 701 may be at top left corner which may be the most likely to be selected by the user. As shown in FIG. 7, the slots may be filled with content or content collections (e.g., social network, games, travels, movies, music, deals, books, pictures, etc.).

The processes described herein for merchandizing online content collections at various layers of a hierarchy may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

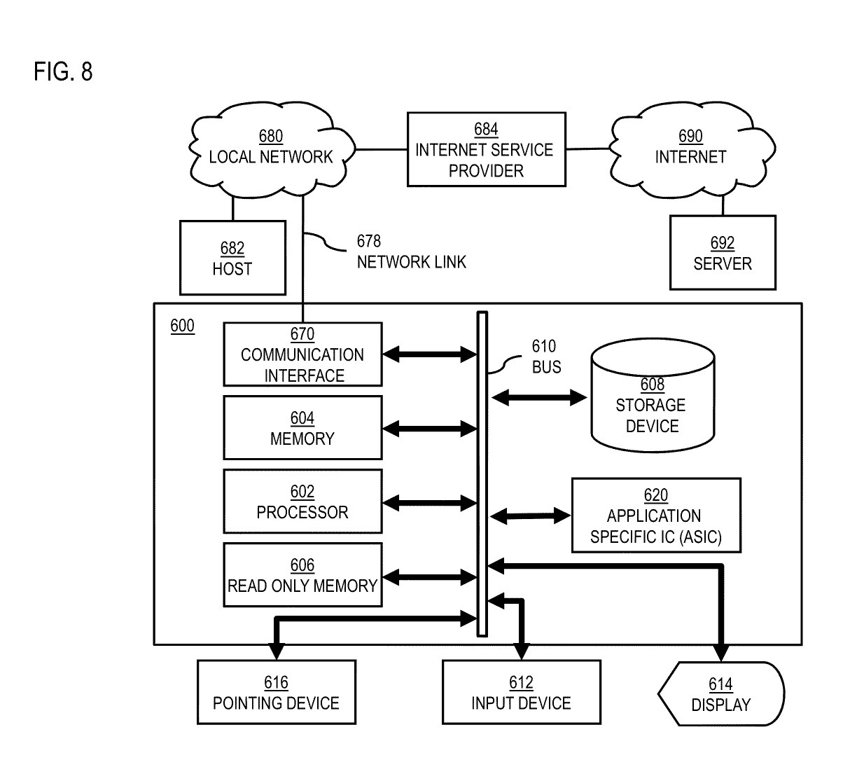

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to merchandize online content collections at various layers of a hierarchy as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of merchandizing online content collections at various layers of a hierarchy.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to merchandizing online content collections at various layers of a hierarchy. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for merchandizing online content collections at various layers of a hierarchy. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for merchandizing online content collections at various layers of a hierarchy, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for merchandizing online content collections at various layers of a hierarchy to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to merchandize online content collections at various layers of a hierarchy as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of merchandizing online content collections at various layers of a hierarchy.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to merchandize online content collections at various layers of a hierarchy. The memory 905 also stores the data associated with or generated by the execution of the inventive steps.

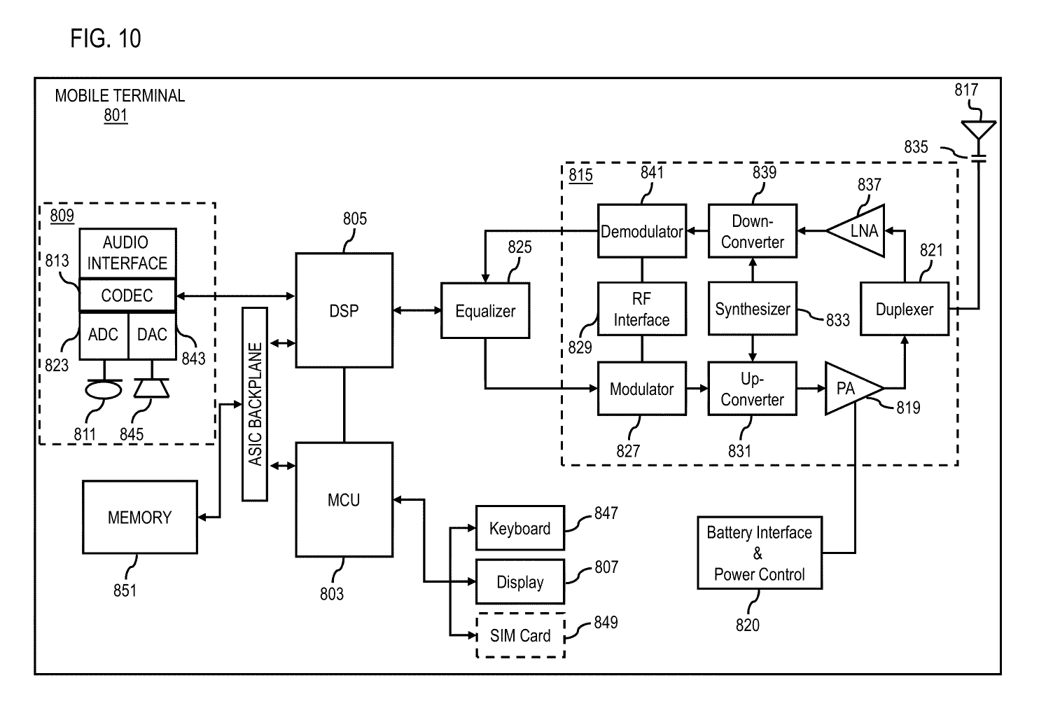

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of merchandizing online content collections at various layers of a hierarchy. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of merchandizing online content collections at various layers of a hierarchy. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to merchandize online content collections at various layers of a hierarchy. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
at least one determination of at least one slot of at least one page associated with one or more content stores, wherein the at least one slot is for presenting one or more content items;
an association of at least one collection of the one or more content items with the at least one slot; and
a selection of at least a portion of the at least one collection to present in the at least one slot.

2. A method of claim 1, wherein the (1) data and/or (2) information and/or (3) at least one signal are further based, at least in part, on the following:
a processing of one or more rules for specifying the one or more content items in the at least one collection.

3. A method of claim 1, wherein the (1) data and/or (2) information and/or (3) at least one signal are further based, at least in part, on the following:
at least one determination of the selection of the at least a portion of the at least one collection based, at least in part, on user milieu information.

4. A method of claim 1, wherein the (1) data and/or (2) information and/or (3) at least one signal are further based, at least in part, on the following:
at least one determination of the selection of the at least a portion of the least one collection based, at least in part, on a randomization of the one or more content items in the at least one collection.

5. A method of claim 1, wherein the selection comprises the at least one collection in at least substantially its entirety.

6. A method of claim 1, wherein the (1) data and/or (2) information and/or (3) at least one signal are further based, at least in part, on the following:
at least one determination of the association of the at least one collection with the at least one slot based, at least in part, on one or more contextual parameters,
wherein the one or more contextual parameters include, at least in part, one or more temporal parameters.

7. A method of claim 1, wherein the (1) data and/or (2) information and/or (3) at least one signal are further based, at least in part, on the following:
at least one determination of the association of the at least one collection with the at least one slot on at a first hierarchical level; and
at least one determination of an input at a second hierarchical level for causing, at least in part, an overriding of the association.

8. A method of claim 7, wherein the first hierarchical level and the second hierarchical level are based, at least in part, on a global level, a regional level, a country level, a local level, or a combination thereof.

9. A method of claim 1, wherein the (1) data and/or (2) information and/or (3) at least one signal are further based, at least in part, on the following:
at least one determination that the at least one slot is unfilled by the at least one collection; and
a processing of one or more backfilling rules to cause, at least in part, a filling of the at least one slot.

10. A method of claim 1, wherein the (1) data and/or (2) information and/or (3) at least one signal are further based, at least in part, on the following:
at least one determination of the selection of the at least a portion of the at least one collection based, at least in part, on an avoidance of a duplication of the one or more items with respect to the at least one slot.

11. An apparatus comprising:
at least one processor; and
at least one memory including computer program code for one or more programs, the at least one memory and the computer program code configured to, with the at least one processor, cause the apparatus to perform at least the following,
determining at least one slot of at least one page associated with one or more content stores, wherein the at least one slot is for presenting one or more content items;
causing, at least in part, an association of at least one collection of the one or more content items with the at least one slot; and
causing, at least in part, a selection of at least a portion of the at least one collection to present in the at least one slot.

12. An apparatus of claim 11, wherein the apparatus is further caused to:
processing and/or facilitating a processing of one or more rules for specifying the one or more content items in the at least one collection.

13. An apparatus of claim 11, wherein the apparatus is further caused to:
determining the selection of the at least a portion of the at least one collection based, at least in part, on user milieu information.

14. An apparatus of claim 11, wherein the apparatus is further caused to:
determining the selection of the at least a portion of the least one collection based, at least in part, on a randomization of the one or more content items in the at least one collection.

15. An apparatus of claim 11, wherein the selection comprises the at least one collection in at least substantially its entirety.

16. An apparatus of claim 11, wherein the apparatus is further caused to:
determining the association of the at least one collection with the at least one slot based, at least in part, on one or more contextual parameters,
wherein the one or more contextual parameters include, at least in part, one or more temporal parameters.

17. An apparatus of claim 11, wherein the apparatus is further caused to:
determining the association of the at least one collection with the at least one slot on at a first hierarchical level; and
determining an input at a second hierarchical level for causing, at least in part, an overriding of the association.

18. An apparatus of claim 17, wherein the first hierarchical level and the second hierarchical level are based, at least in part, on a global level, a regional level, a country level, a local level, or a combination thereof.

19. An apparatus of claim 11, wherein the apparatus is further caused to:
determining that the at least one slot is unfilled by the at least one collection; and
processing and/or facilitating a processing of one or more backfilling rules to cause, at least in part, a filling of the at least one slot.

20. An apparatus of claim 11, wherein the apparatus is further caused to:
determining the selection of the at least a portion of the at least one collection based, at least in part, on an avoidance of a duplication of the one or more items with respect to the at least one slot.

21-47. (canceled)
